(19) United States
(12) Patent Application Publication
(10) Pub. No.: US 2022/0103919 A1
(43) Pub. Date: Mar. 31, 2022

(54) SOUND OUTPUT DEVICE

(71) Applicant: SONY GROUP CORPORATION, Tokyo (JP)

(72) Inventors: Sai KARASAWA, Tokyo (JP); Masaaki OHARA, Tokyo (JP); Tetsu SUMII, Tokyo (JP); Daigaku KUMANO, Tokyo (JP)

(73) Assignee: SONY GROUP CORPORATION, Tokyo (JP)

(21) Appl. No.: 17/426,712

(22) PCT Filed: Dec. 12, 2019
(86) PCT No.: PCT/JP2019/048751

§ 371 Date: Jul. 29, 2021

(30) Foreign Application Priority Data
Feb. 8, 2019 (JP) 2019-021973

(51) Int. Cl. H04R 1/02

(52) U.S. Cl. CPC H04R 1/026

(57) ABSTRACT

Provided is a sound output device including an outer housing which includes a sound emission hole and in which an internal space is formed as a disposition space, and a speaker which is disposed in the disposition space and outputs a sound outward through the sound emission hole, and the sound output device is attachable or detachable to or from a holder attached to a garment. Thereby, the sound output device can be removed from the holder in an unused state or during maintenance, a failure or damage hardly occurs, an improvement in workability in maintenance work is also achieved, and an improvement in usability can be achieved.

### TECHNICAL FIELD

The present technology relates to a technical field regarding a sound output device in which a speaker is disposed inside an outer housing.

### BACKGROUND ART

There are sound output devices that output sound from speakers, and some of such sound output devices are attached to a garment and used with the garment being worn on the body (see, for example, PTL 1).

In the sound output device disclosed in PTL 1, a pair of waterproof type speakers are previously attached to right and left shoulder portions in a garment, the pair of speakers are connected to each other by a wiring, and one of the speakers is connected to an amplifier, a receiver, and a battery, which function as ancillary devices, by a wiring. The amplifier, the receiver, and the battery are used in a state where these are inserted into, for example, a pocket or the like of a garment.

### CITATION LIST

### Patent Literature

[PTL 1]

JP 2003-268609A

### SUMMARY

### Technical Problem

Incidentally, in the above-described sound output devices that are used with a garment worn on the body, the garment may be washed. In this case, there is a concern that the sound output device may be broken or damaged due to an impact or the like during washing. In addition, also when maintenance due to a failure is performed, it is necessary to perform the maintenance while the sound output device is attached to a garment, and thus workability in the maintenance work is also impaired.

Thus, there is a possibility that usability will be reduced due to such concern regarding a failure or damage or impairing of workability in maintenance work.

Consequently, an object of the sound output device of the present technology is to achieve an improvement in usability.

### Solution to Problem

Firstly, a sound output device according to the present technology includes an outer housing which includes a sound emission hole and in which an internal space is formed as a disposition space, and a speaker which is disposed in the disposition space and outputs sound outward through the sound emission hole, in which the sound output device is attachable or detachable to or from a holder attached to a garment.

Thereby, the sound output device can be removed from the holder in a state in which it is not being used or during maintenance.

Secondly, in the above-described sound output device, it is preferable that the sound output device be disposed on an upper side of a shoulder in a state of being mounted on the holder.

Thereby, since the shoulder is a portion that is not greatly displaced when the body is moved and is a portion close to the ear, the sound output device is disposed at a position close to the ear and the sound output device is not greatly displaced when the body moves.

Thirdly, in the above-described sound output device, it is preferable that the sound output device be disposed on a side behind a hollow positioned behind a collarbone.

Thereby, the orientation of the sound output device hardly changes in a state where the sound output device is disposed in the holder.

Fourthly, in the above-described sound output device, it is preferable that the sound output device be attachable or detachable to or from the holder in an up-down direction.

Thereby, it is possible to attach or detach the sound output device for the holder to or from the shoulder by moving a hand vertically.

Fifthly, in the above-described sound output device, it is preferable that a concave-shaped disposition portion be formed in the holder, and the sound output device be disposed in a state where a portion thereof is inserted into the disposition portion.

Thereby, the sound output device is mounted on the holder in a state where a portion thereof is inserted into the disposition portion.

Sixthly, in the above-described sound output device, it is preferable that an emission port of the sound emission hole be positioned outside the disposition portion in a state where the sound output device is inserted into the disposition portion.

Thereby, the emission port of the sound emission hole is not blocked by the holder in a state where the sound output device is inserted into the disposition portion.

Seventhly, in the above-described sound output device, it is preferable that the holder be provided with a pressing portion that presses the outer housing from a direction opposite to an opening direction of the disposition portion.

Thereby, the sound output device is inserted into the disposition portion and is mounted on the holder in a state where the outer housing is pressed by the pressing portion from a direction opposite to the opening direction of the disposition portion.

Eighthly, in the above-described sound output device, it is preferable that the sound output device be formed to have an asymmetrical shape in a right-left direction.

Thereby, it is possible to recognize a direction in which the sound output device is mounted on the holder depending on the shape thereof.

Ninthly, in the above-described sound output device, it is preferable that a pair of right and left sound output devices be provided, and the right and left sound output devices be mounted on the holder in a laterally symmetrical direction.

Thereby, it is possible to recognize on which holder out of the holders on the right and left sides the sound output device is mounted depending on the direction thereof.

Tenthly, in the above-described sound output device, it is preferable that an outer surface portion of the outer housing include a flat surface portion and a curved surface portion which is continuous with an outer periphery of the flat surface portion.

Thereby, an angled portion is not formed on the outer surface of the outer housing, and thus a sense of incongruity is unlikely to be caused when the sound output device is gripped.

Eleventhly, in the above-described sound output device, it is preferable that a magnet be attached to one of the outer housing and the holder, and a magnetic metal plate be attached to the other one, and the sound output device be mounted on the holder in a state where the magnetic metal plate is stuck onto the magnet.

Thereby, the sound output device is mounted on the holder by the magnet and the magnetic metal plate approaching each other, and the sound output device is removed from the holder by the magnet and the magnetic metal plate being separated from each other.

Twelfthly, in the above-described sound output device, it is preferable that the magnet be attached to the outer housing, and the magnetic metal plate be attached to the holder.

Thereby, the magnet is not present on the garment side in a state where the sound output device is not mounted on the holder.

Thirteenthly, in the above-described sound output device, it is preferable that the outer housing be formed in a shape having a longitudinal direction and a transverse direction, and a plurality of the magnets be provided to be separated from each other in the longitudinal direction of the outer housing.

Thereby, the sound output device is mounted on the holder by the magnetic metal plate being stuck onto the plurality of magnets which are disposed to be separated from each other in the longitudinal direction of the outer housing.

Fourteenthly, in the above-described sound output device, it is preferable that an attaching/detaching direction with respect to the holder be a thickness direction, two directions orthogonal to the thickness direction be a length direction and a width direction, and a size in the thickness direction be smaller than sizes in the length direction and the width direction.

Thereby, the size in the thickness direction matching the attaching/detaching direction is smaller than the sizes in the length direction and the width direction.

Fifteenthly, in the above-described sound output device, it is preferable that a battery be disposed in the disposition space, and a thickness direction of the battery match the thickness direction of the outer housing.

Thereby, it is possible to achieve effective utilization of a disposition space of the disposition space and dispose the large-sized battery in the disposition space.

Sixteenthly, in the above-described sound output device, it is preferable that a plurality of circuit boards be disposed in the disposition space, and a thickness direction of at least one of the circuit boards match the thickness direction of the outer housing.

Thereby, the thickness directions of the at least one of the circuit boards and the battery match each other.

Seventeenthly, in the above-described sound output device, it is preferable that one of the circuit boards be disposed in a state of being inclined with respect to the thickness direction of the outer housing.

Thereby, one of the circuit boards is disposed in the disposition space in a state where the thickness direction thereof is different from the thickness direction of the outer housing, and thus sizes in two directions, that is, the thickness direction of the outer housing and a direction orthogonal to the thickness direction are not increased excessively.

Eighteenthly, in the above-described sound output device, it is preferable that at least one of the circuit boards, the battery, and the speaker be disposed to be separated from each other in a direction orthogonal to the thickness direction of the outer housing.

Thereby, at least one of the circuit boards, the battery, and the speaker are disposed in a state where they do not overlap each other in the thickness direction of the outer housing.

Ninteenthly, in the above-described sound output device, it is preferable that the sound emission hole be inclined with respect to both the thickness direction of the outer housing and a direction orthogonal to the thickness direction.

Thereby, the emission ports in the sound emission holes can be positioned at any location of the outer housing.

Twentiethly, in the above-described sound output device, it is preferable that a button disposition hole be formed in the outer housing, an operation portion be disposed in the button disposition hole, a protection cover formed of a cloth material be adhered to at least a portion of a surface in the outer housing, and the operation portion be covered with the protection cover.

Thereby, the operation portion is not exposed.

### BRIEF DESCRIPTION OF DRAWINGS

FIG. 1 is a diagram showing a sound output device according to an embodiment of the present technology together with FIGS. 2 to 12 and showing each part of a human body.

FIG. 2 is a perspective view showing a state where the sound output device is removed from a holder.

FIG. 3 is a perspective view showing a state where the sound output device is mounted on the holder.

FIG. 4 is a side view conceptually showing a state where the sound output device is mounted on the holder.

FIG. 5 is a perspective view of the sound output device.

FIG. 6 is a perspective view of the sound output device showing a state where a cover body and a protection rubber piece are separated from a case body.

FIG. 7 is an exploded perspective view of the sound output device.

FIG. 8 is a cross-sectional view taken along a line VIII-VIII of FIG. 5.

FIG. 9 is a cross-sectional view taken along a line IX-IX of FIG. 5.

FIG. 10 is a plan view conceptually showing a positional relationship between portions in a state where the cover body and the protection rubber are removed.

FIG. 11 is a perspective view showing the holder including a pressing portion, and the sound output device.

FIG. 12 is a side view conceptually showing a state where the sound output device is mounted on the holder including the pressing portion.

### DESCRIPTION OF EMBODIMENTS

Hereinafter, an embodiment for implementing a sound output device of the present technology will be described with reference to the accompanying drawings.

In addition, a sound output device to be described below is mounted on a holder attached to a garment and disposed on an upper side of a shoulder. In the following description, it is assumed that front-back, right-left, and up-down directions in the sound output device are shown in accordance with the orientation of the sound output device disposed at the shoulder.

However, front-back, up-down, and right-left directions to be described below are for convenience of description, and the implementation of the present technology is not limited to these directions.

<Human Body>

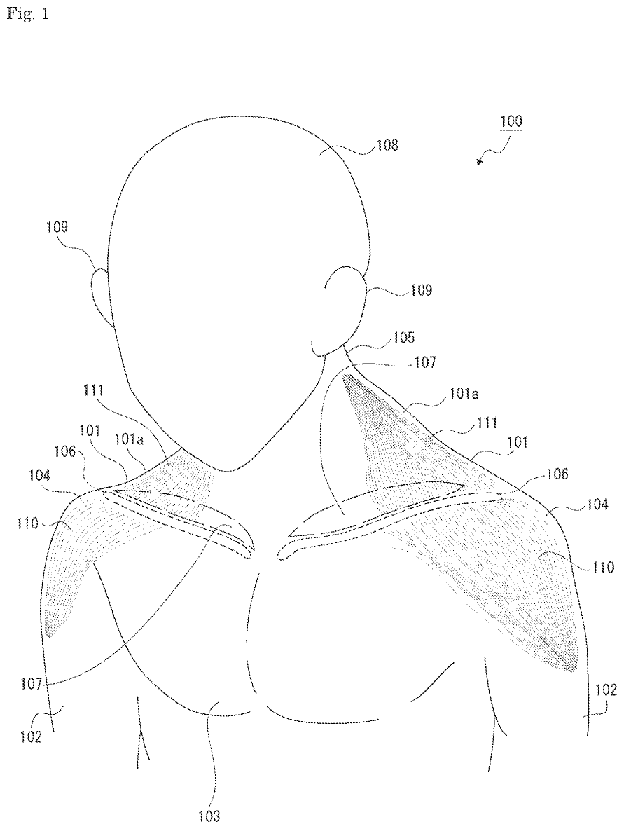

First, a human body will be described (see FIG. 1).

A shoulder 101 of a human body 100 is a part ranging from an arm 102 and a root portion 104 of the trunk 103 to the neck 105 in the right-left direction, and is a part from a collarbone 106 to a shoulder blade not shown in the drawing in the front-back direction. Although it depends on a physique, a hollow 107 is generally present immediately behind the collarbone 106, and a shoulder upper portion 101a is present behind the hollow 107. Ears 109 and 109 of the face 108 which is an upper part of the neck 105 are respectively present above the shoulders 101 and 101 near the shoulders 101 and 101.

In the human body 100, a muscle called a deltoid muscle 110 is present in the vicinity of a region from the root portion 104 to an upper arm part of the arm 102, and a muscle called a trapezius muscle 111 is present in the vicinity of a region from an upper part of a back to the shoulder 101 on the neck 105 side of the deltoid muscle 110. Thus, the vicinity of an upper portion of the trapezius muscle 111 is a part corresponding to the shoulder upper portion 101a.

<Garment, Sheet, and Holder>

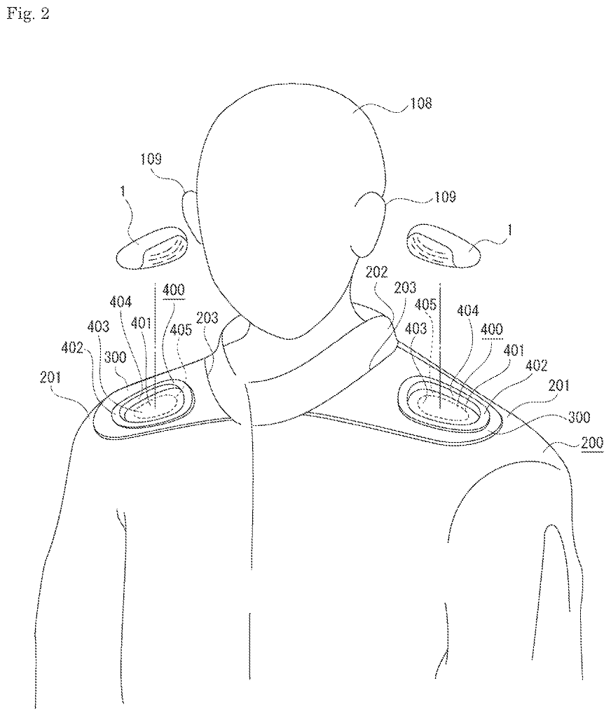

Next, a garment, a sheet, and a holder will be described (see FIGS. 2 to 4).

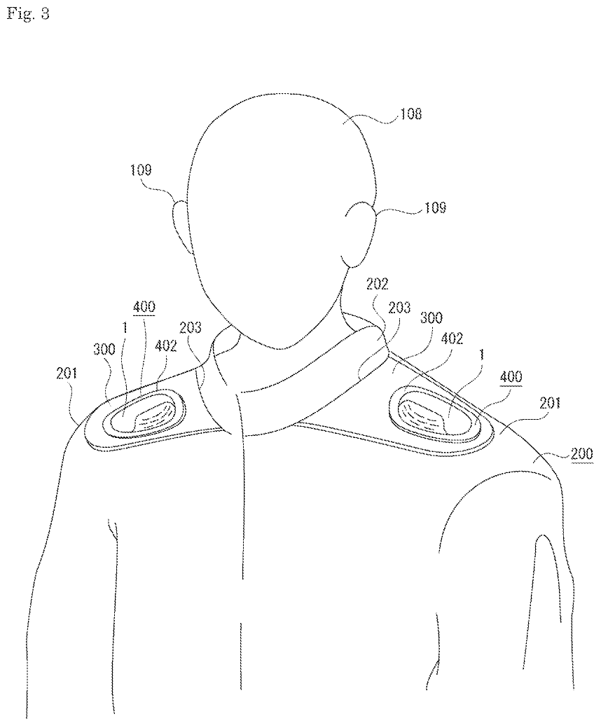

A garment 200 is wrapped around the human body 100 as, for example, sportswear (see FIGS. 2 and 3). In the garment 200, parts corresponding to the shoulders 101 and 101 are provided as shoulder portions 201 and 201, respectively. The garment 200 is provided with a collar portion 202 corresponding to a lower portion of the neck 105, and boundary lines between the shoulder portions 201 and 201 and the collar portion 202 are formed as seams 203 and 203.

Sheets 300 and 300 are adhered to the shoulder portions 201 and 201 respectively. The sheet 300 is adhered to, for example, a position where one end thereof matches the seam 203. A mounting hole which is not shown in the drawing is formed in the sheet 300.

A holder 400 is adhered to the sheet 300. The holder 400 includes a disposition portion 401 opening substantially upward and formed to have a shallow concave shape, and a flange-shaped junction portion 402 extending outward from an opening 401a of the disposition portion 401, and the junction portion 402 is bonded to the sheet 300 in a state where the disposition portion 401 is inserted into a mounting hole of the sheet 300 from above.

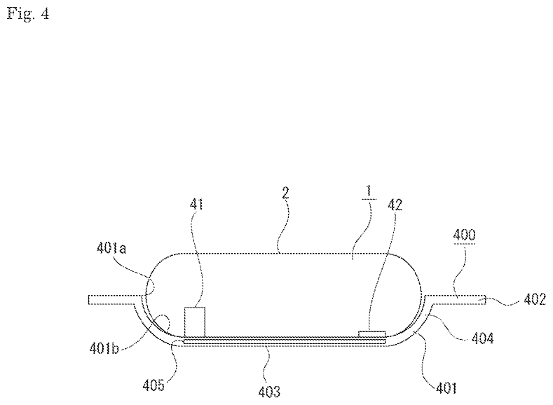

An internal space of the disposition portion 401 is formed as an insertion space 401b (see FIG. 4). A bottom surface portion 403 of the disposition portion 401 is formed, for example, in a planar shape, and a peripheral surface portion 404 of the disposition portion 401 is formed, for example, in a gentle curved surface shape in which the diameter thereof increases as a distance from the bottom surface portion 403 increases. A magnetic metal plate 405 is mounted inside the bottom surface portion 403 in the disposition portion 401.

The holder 400 is positioned on the upper side of the shoulder 101, and particularly, on the upper side of the shoulder upper portion 101a in a state where the garment 200 is wrapped around the human body 100.

<Configuration of Sound Output Device>

Subsequently, a configuration of the sound output device 1 will be described (see FIGS. 2 to 10).

For example, a pair of sound output devices 1 are used, and one of the sound output devices 1 is used as a left sound output device, and the other sound output device 1 is used as a right sound output device (see FIGS. 2 and 3). However, sound may be heard using one sound output device 1.

The sound output devices 1 and 1 are disposed to be respectively inserted into the disposition portions 401 and 401 of the holders 400 and 400. Portions on lower end sides of the sound output devices 1 are inserted into the disposition portions 401, and outer surfaces of the inserted portions are in contact with or in proximity to the bottom surface portion 403 and the peripheral surface portion 404 (see FIG. 4).

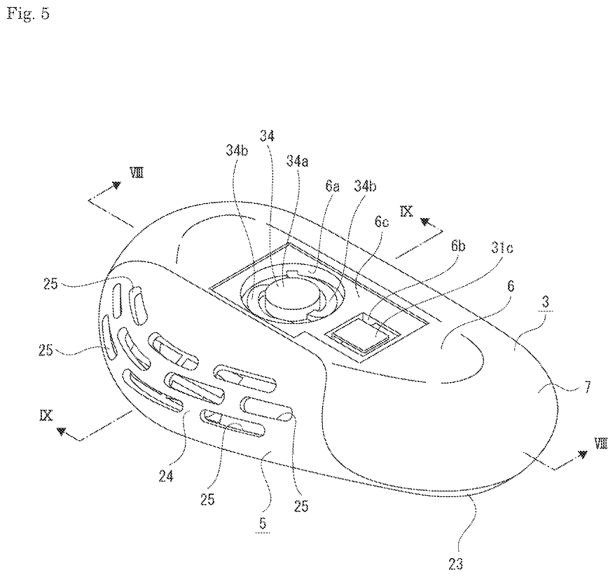

The sound output device 1 is configured such that each of predetermined parts is disposed inside an outer housing 2 (see FIGS. 5 to 9). The outer housing 2 includes a cover body 3, a case body 4, and a protection rubber 5. The cover body 3 and the case body 4 are formed of, for example, a resin material, and the protection rubber 5 is formed of, for example, a silicon material.

The cover body 3 is formed to have a concave shape that opens downward as a whole, and includes a flat surface portion 6 facing in an up-down direction, a curved surface portion 7 connected to the outer periphery of the flat surface portion 6, a coupling protrusion 8 protruding downward from the flat surface portion 6, and pressing protrusions 9, 9, . . . protruding downward from the flat surface portion 6. The cover body 3 is provided with a hold forming portion 10 connected to a front end portion of the curved surface portion 7, and the hold forming portion 10 has a thickness larger than those of the flat surface portion 6 and the curved surface portion 7.

An outer peripheral surface portion of the cover body 3 includes the flat surface portion 6 and the curved surface portion 7 which is continuous with the outer periphery of the flat surface portion 6, and thus the cover body is formed to have a shape having no angled portions.

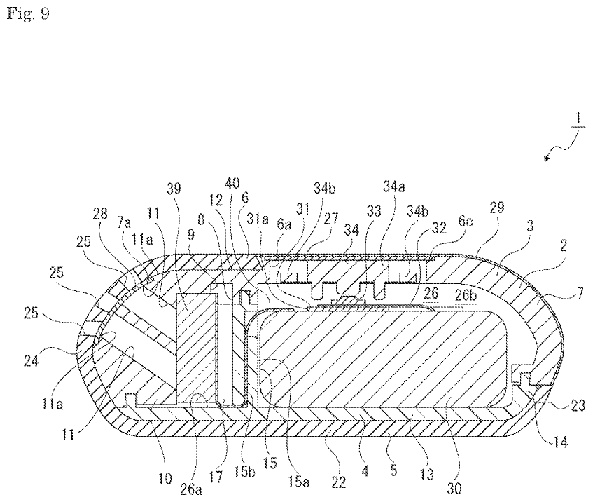

sound emission holes 11, 11, . . . are formed at a position ranging from the hold forming portion 10 to the curved surface portion 7 which is continuous with the hold forming portion 10. The sound emission holes 11, 11, . . . are formed to be arranged on the upper, lower, right, and left sides and are inclined to be displaced upward as they move forward (see FIG. 9). An outer opening of the sound emission hole 11 is configured as an emission port 11a from which a sound is emitted.

A button disposition hole 6a and a member insertion hole 6b are formed on the right and left sides in the flat surface portion 6 so as to be separated from each other (see FIGS. 5 to 8). On an upper surface side of the flat surface portion 6, a shallow sheet disposition concave portion 6c is formed in a region in which a button disposition hole 6a and a member insertion hole 6b are formed.

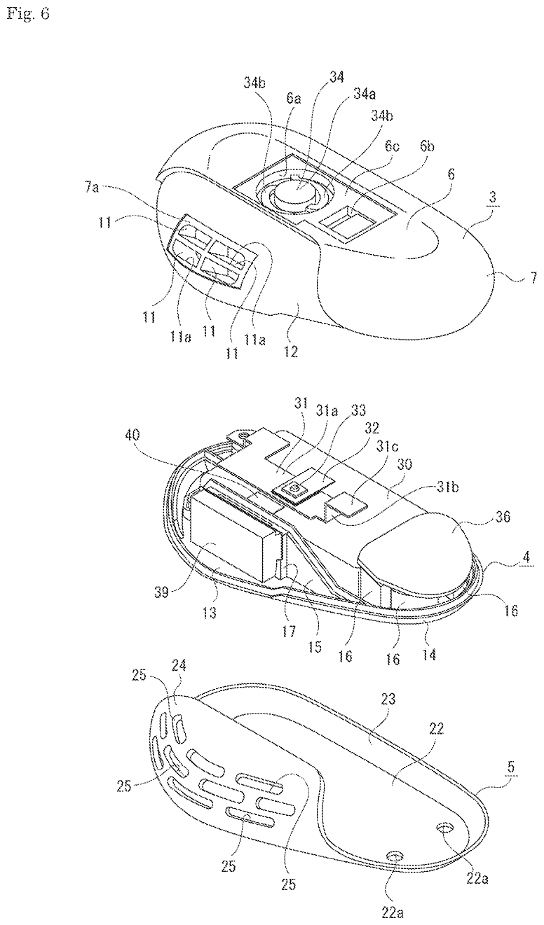

A counterbore portion 12 is formed on an outer surface side of the front end portion in the curved surface portion 7, and the curved surface portion 7 is formed such that the front end portion is thinner than the other portions by the counterbore portion 12 (see FIGS. 6, 7, and 9). A shallow sheet disposition concave portion 7a is formed in a region in which the sound emission holes 11, 11, . . . of the front end portion in the curved surface portion 7 are formed.

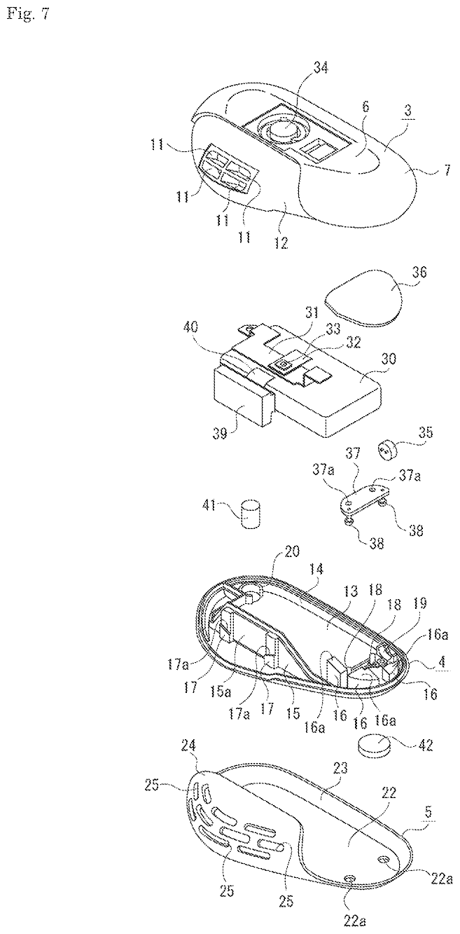

The case body 4 is formed to have a shallow concave shape that opens upward as a whole, and includes a planar plate portion 13 facing in an up-down direction, a curved plate portion 14 connected to the outer periphery of the planar plate portion 13, a coupling protrusion 15 protruding upward from the planar plate portion 13, and disposition protrusions 16, 16, and 16 protruding upward from the planar plate portion 13 (see FIGS. 7 to 9).

The coupling protrusion 15 is a portion which is vertically coupled to the coupling protrusion 8 provided in the cover body 3, and is formed to have a wall shape. The coupling protrusion 15 is provided with a wall-shaped portion 15a facing in a front-back direction at an intermediate portion thereof in the right-left direction, and the wall-shaped portion 15a has the largest height in the coupling protrusion 15.

positioning protrusions 17 and 17 protrude forward from the front surface of the wall-shaped portion 15a. The positioning protrusions 17 and 17 are provided on the right and left sides so as to be separated from each other, and respectively include inclined stepped portions 17a and 17a for positioning on the front surface sides thereof. The inclined stepped portions 17a and 17a are inclined to be displaced downward as they approach each other in the right-left direction.

An insertion slit 15b is formed in the wall-shaped portion 15a of the coupling protrusion 15 (see FIG. 9). The insertion slit 15b is formed at a position ranging from the front surface of the lower end portion in the wall-shaped portion 15a to the back surface of the upper end portion thereof, and is formed such that an intermediate portion thereof penetrates the wall-shaped portion 15a vertically.

The disposition protrusions 16, 16, and 16 protrude upward from right and left end portions in the planar plate portion 13 and are provided to be arranged along the inner peripheral surface of the curved plate portion 14. The upper surfaces of the disposition protrusions 16, 16, and 16 are formed as inclined disposition surfaces 16a, 16a, and 16a that are displaced upward as they approach the center of the planar plate portion 13 in the right-left direction.

The outer peripheral surface portion of the case body 4 is constituted by the planar plate portion 13 and the curved plate portion 14 connected to the outer periphery of the planar plate portion 13, and thus the outer peripheral surface portion is formed to have a shape having no angled portion.

positioning pins 18 and 18 protrude upward from right and left end portions in the planar plate portion 13, and the positioning pins 18 and 18 are positioned to be separated from each other in a front-back direction. A terminal insertion hole which is not shown in the drawing is formed on the side of each of the positioning pins 18 and 18 in the planar plate portion 13.

A microphone mounting portion 19 is provided in the vicinity of the disposition protrusion 16 positioned on the rearmost side, and the microphone mounting portion 19 protrudes upward from the planar plate portion 13 (see FIG. 7).

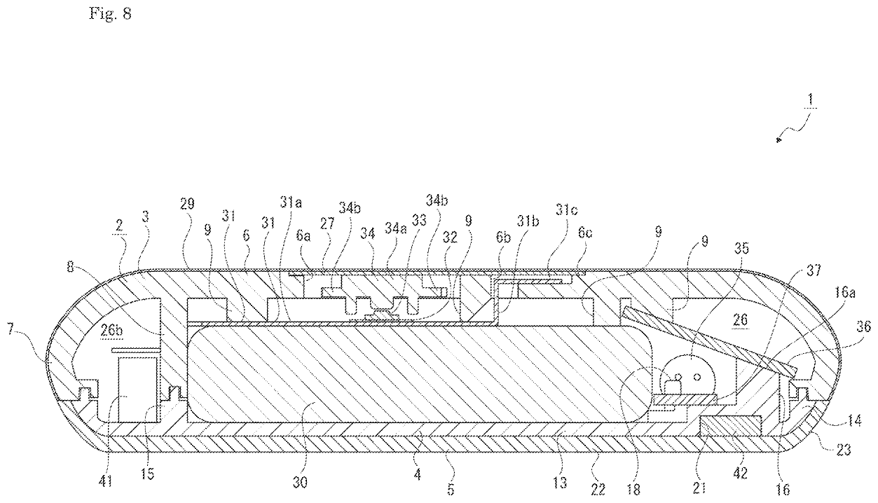

The case body 4 is provided with a circumferential first magnet mounting portion 20 at one-end portion thereof in the right-left direction, and is provided with a concave-shaped second magnet mounting portion 21 that opens downward at the other-end portion thereof in the right-left direction (see FIGS. 7 and 8). The first magnet mounting portion 20 is provided on an upper surface side of the planar plate portion 13, and the second magnet mounting portion 21 is provided on a lower surface side of the planar plate portion 13.

The protection rubber 5 includes a flat surface portion 22 facing in the up-down direction, a first curved surface portion 23 connected to the outer periphery of the flat surface portion 22, and a second curved surface portion 24 connected to an upper edge of the first curved surface portion 23 (see FIGS. 6 and 7).

The flat surface portion 22 is a portion that covers the planar plate portion 13 of the case body 4 from below, and is formed to have substantially the same shape and size as those of the planar plate portion 13. Insertion holes 22a and 22a are formed in right and left end portions in the flat surface portion 22 so as to be separated from each other in a front-back direction.

The first curved surface portion 23 is a portion that covers the curved plate portion 14 of the case body 4 from the outside, and is formed to have substantially the same shape and size as those of the curved plate portion 14.

The second curved surface portion 24 is a portion that covers a portion having the counterbore portion 12 of the curved surface portion 7 in the cover body 3 formed therein from the outside, and is formed to have substantially the same shape and size as those of the portion in which the counterbore portion 12 of the curved surface portion 7 is formed. Sound discharge holes 25, 25, . . . are formed in the second curved surface portion 24, and the sound discharge holes 25, 25, . . . are formed, for example, in a horizontally long shape so as to be arranged on the upper, lower, right, and left sides.

The cover body 3 and the case body 4 configured as described above are coupled to each other by a lower end portion of the curved surface portion 7 and an upper end portion of the curved plate portion 14 abutting on each other and a lower end portion of the coupling protrusion 8 and an upper end portion of the coupling protrusion 15 abutting on each other (see FIGS. 8 and 9). A space is formed between the cover body 3 and the case body 4 being coupled to each other, and the space is a disposition space 26. The curved surface portion 7 and the curved plate portion 14 are fixed and adhere to each other, for example, by adhesion, thereby achieving waterproofness against the disposition space 26.

In a state where the cover body 3 and the case body 4 are coupled to each other, the disposition space 26 is partitioned in a front-back direction by the coupling protrusion 8 and the coupling protrusion 15, and separate spaces of the disposition space 26 are formed as a front side space 26a and a rear side space 26b.

A waterproof sheet 27 formed of silicon is disposed in the sheet disposition concave portion 6c formed in the flat surface portion 6 of the cover body 3, and a mesh-shaped dustproof sheet 28 is disposed in the sheet disposition concave portion 7a formed in the curved surface portion 7 of the cover body 3.

Infiltration of moisture into the disposition space 26 from the button disposition hole 6a and the member insertion hole 6b of the cover body 3 is prevented by the waterproof sheet 27 being disposed in the sheet disposition concave portion 6c. Infiltration of dust into the disposition space 26 from the sound emission holes 11, 11, . . . of the cover body 3 is prevented by the dustproof sheet 28 being disposed in the sheet disposition concave portion 7a.

In a state where the cover body 3 and the case body 4 are coupled to each other, a protection rubber 5 is attached to closely adhere to the cover body 3 and the case body 4. In a state where the protection rubber 5 is attached to closely adhere to the cover body 3 and the case body 4, the planar plate portion 13 of the case body 4 is covered with the flat surface portion 22 from below, the curved plate portion 14 of the case body 4 is covered with the first curved surface portion 23 from the outside, and the portion having the counterbore portion 12 of the curved surface portion 7 in the cover body 3 formed therein is covered with the second curved surface portion 24 from the outside.

A protection cover 29 formed of, for example, a cloth material similar to that of the garment 200 is adhered to a portion in which the counterbore portion 12 is not formed in the cover body 3.

The cover body 3 and the case body 4 to which the protection cover 29 is adhered are coupled to each other, the outer housing 2 is constituted by the protection rubber 5 being attached to the cover body 3 and the case body 4 as described above, and the outer surface of the protection rubber 6 and the outer surface of the protection cover 29 are positioned on a continuous collinear surface in the outer housing 2.

Since the outer housing 2 is formed by the outer surface portion being continuous with the flat surface portion 6 or the flat surface portion 22 and the curved surface portion 7 or the curved surface portion 23, an angled portion is not formed on outer surface of the outer housing 2, and thus a sense of incongruity is unlikely to be caused when the sound output device 1 is gripped, thereby making it possible to secure good gripping properties in the sound output device 1.

A battery 30 is disposed in the rear side space 26b of the outer housing 2 (see FIGS. 6 to 9). The battery 30 is formed in, for example, a substantially flat rectangular parallelepiped shape and is disposed in the rear side space 26b in a direction in which the thickness direction thereof matches an up-down direction, and the longitudinal direction thereof matches a right-left direction.

A part excluding a portion of a disposition sheet metal 31 is disposed in the rear side space 26b of the outer housing 2. The disposition sheet metal 31 is formed to bent in a predetermined shape, and includes a base portion 31a placed on an upper surface of the battery 30, a connecting portion 31b protruding upward from one-end portion of the base portion 31a in the right-left direction, and an engagement portion 31c protruding laterally from the connecting portion 31b.

In the disposition sheet metal 31, the connecting portion 31b is inserted into the member insertion hole 6b of the cover body 3, and the engagement portion 31c engages with a portion in which the sheet disposition concave portion 6c is formed on the upper surface of the cover body 3. The disposition sheet metal 31 is pressed from above by the pressing protrusions 9, 9, . . . of the cover body 3, and is pressed against the upper surface of the battery 30 through, for example, an insulating sheet not shown in the drawing.

A circuit board 32 for a switch is disposed on the upper surface of the base portion 31a in the disposition sheet metal 31, and a switch 33 is mounted on the circuit board 32 for a switch.

An operation button 34 is disposed in the button disposition hole 6a of the cover body 3, and the operation button 34 includes a disc-shaped pressed portion 34a and spring portions 34b and 34b of which one-end portions thereof are respectively connected to the pressed portion 34a (see FIGS. 5 to 9).

For example, the operation button 34 is formed integrally with the flat surface portion 6 of the cover body 3, and the other-end portions of the spring portions 34b and 34b are continuous with the peripheral surface of the button disposition hole 6a in the flat surface portion 6.

In the operation button 34, when a pressing operation on the pressed portion 34a is performed, the spring portions 34b and 34b are elastically deformed with respect to the pressed portion 34a and the flat surface portion 6. When the pressing operation on the pressed portion 34a is released, the spring portions 34b and 34b are elastically restored and the pressed portion 34a returns to the original position before the pressing operation. When a pressing operation on the pressed portion 34a is performed, the switch 33 is pressed by the pressed portion 34a, and various modes and the like are set.

For example, turn-on or turn-off of a power supply, setting of a sound output mode, setting of a sound output stop mode, and the like are performed by operating the operation button 34. Such settings are performed in accordance with an operation state such as the number of operations of the operation button 34, or an operation state such as long-time pressing or short-time pressing performed on the operation button 34.

The operation button 34 and the engagement portion 31c of the disposition sheet metal 31 are covered with the waterproof sheet 27, and the waterproof sheet 27 is covered with the protection cover 29. In addition, there is a possibility that the position of the operation button 34 cannot be visually recognized in a state where the operation button 34 is covered with the waterproof sheet 27 and the protection cover 29, but the position of the operation button 34 can be recognized from the outside of the protection cover 29, for example, by marking a portion where the operation button 34 is positioned at the protection cover 29.

The operation portion 34 and a portion of the disposition sheet metal 31 are covered with the protection cover 29 formed of a cloth material in this manner, and thus the operation portion 34 and the disposition sheet metal 31 are not exposed, thereby making it possible to achieve an improvement in the design of the sound output device 1.

In addition, the protection cover 29 is formed of a cloth material, and thus a sense of unity with the garment 200 making the sound output device 1 inconspicuous is given in a state where the sound output device 1 is disposed in the garment 200, thereby making it possible to secure good fashionableness in a state where the garment 200 having the sound output device 1 disposed thereon is worn on the body.

A microphone 35, a main circuit board 36, and a sub-circuit board 37 are disposed in the rear side space 26b of the outer housing 2 (see FIGS. 7 and 8).

The microphone 35 is disposed to be attached to the microphone mounting portion 19 of the cover body 3. It is possible to input a user's sound by providing the microphone 35 in the sound output device 1.

The main circuit board 36 has a function of performing control and the like related to the output of a sound in the sound output device 1, and is disposed in the rear side space 26b by being partially placed on the disposition protrusions 16, 16, and 16 of the cover body 3. In this case, the upper surfaces of the disposition protrusions 16, 16, and 16 are formed as the inclined disposition surfaces 16a, 16a, and 16a, and thus the main circuit board 36 is disposed in the rear side space 26b in a state of being inclined with respect to the right-left direction. A portion of the main circuit board 36 is pressed from above by the pressing protrusion 9 of the cover body 3.

The sub-circuit board 37 has a function of performing control related to charging in the sound output device 1. Positioning holes 37a and 37a are formed in the sub-circuit board 37 so as to be separated from each other in a front-back direction. Charging terminals 38 and 38 are connected to the sub-circuit board 37 so as to be separated from each other in a front-back direction, and the charging terminals 38 and 38 protrude downward from the sub-circuit board 37.

The sub-circuit board 37 is positioned at the cover body 3 by the positioning pins 18 and 18 being respectively inserted into the positioning holes 37a and 37a from below, and is disposed immediately below the main circuit board 36. The charging terminals 38 and 38 connected to the sub-circuit board 37 are respectively inserted into the terminal insertion holes of the cover body 3, and lower end portions thereof are positioned in the vicinity of the insertion holes 22a and 22a of the protection rubber 5.

When the sound output device 1 is connected to charging equipment not shown in the drawing, a connection terminal of the charging equipment is connected to the charging terminals 38 and 38, whereby charging of the battery 30 is performed by the charging terminals 38 and 38 and the sub-circuit board 37.

The above-described circuit board 32 for a switch, main circuit board 36, and sub-circuit board 37 are all connected to the battery 30 and receive the supply of power from the battery 30. In addition, the microphone 35 is connected to the main circuit board 36, is controlled by the main circuit board 36, and receives the supply of power from the battery 30 through the main circuit board 36.

A speaker 39 is disposed in the front side space 26a of the outer housing 2 (see FIGS. 7 and 9). The speaker 39 is formed to have, for example, a substantially flat rectangular parallelepiped shape and is disposed in the front side space 26a in a direction in which the thickness direction thereof matches a front-back direction, and the width direction thereof matches the up-down direction.

A pair of inclined protrusions not shown in the drawing are formed on the rear surface side of the speaker 39 so as to be separated from each other on the right and left sides, and the speaker 39 is positioned at the positioning protrusions 17 and 17 by the pair of inclined protrusions engaging with the respective inclined stepped portions 17a and 17a.

The speaker 39 is configured such that the width direction thereof is smaller than the length direction thereof, is positioned at the cover body 3 by the positioning protrusions 17 and 17 in the length direction, and is configured such that the front surface thereof is in contact with the rear surface of the hold forming portion 10, and is disposed in the front side space 26a in a horizontally long state. The speaker 39 is configured such that the upper surface thereof is pressed from above by the pressing protrusion 9 of the cover body 3.

The speaker 39 and the battery 30 are connected to each other by a flexible printed wiring plate 40, and the flexible printed wiring plate 40 is inserted into the insertion slit 15b formed in the wall-shaped portion 15a. A pair of inclined edges not shown in the drawing are formed in a portion of the flexible printed wiring plate 40 which is positioned in front of the wall-shaped portion 15a so as to be separated from each other on the right and left sides, and the flexible printed wiring plate 40 is positioned at the positioning protrusions 17 and 17 by the pair of inclined edges engaging with the respective inclined stepped portions 17a and 17a.

A first magnet 41 and a second magnet 42 are respectively attached to the first magnet mounting portion 20 and the second magnet mounting portion 21 of the case body 4. Thus, the first magnet 41 and the second magnet 42 are disposed on both right and left end portions of the outer housing 2, respectively.

In the sound output device 1, the first magnet 41 is disposed in the rear side space 26b, and the second magnet 42 is disposed on the lower surface side of the case body 4. Thus, magnetic forces of the first magnet 41 and the second magnet 42 are unlikely to be influenced on the speaker 39 disposed in the front side space 26a. In addition, the first magnet 41 and the second magnet 42 are disposed so as to be separated from each other in the longitudinal direction of the outer housing 2, and the speaker 39 is disposed in substantially a central portion in the longitudinal direction of the outer housing 2. Thus, magnetic forces of the first magnet 41 and the second magnet 42 are further unlikely to be influenced on the speaker 39.

Thus, the speaker 39 is unlikely to be affected by magnetic forces of the first magnet 41 and the second magnet 42, and thus it is possible to secure a good operation state of the speaker 39.

The sound output device 1 configured as described above is formed to have an asymmetrical shape in the right-left direction, and is formed to have a shape in which a portion having the maximum front-back width is present in a half part positioned on the neck 105 side in the right-left direction, and the front-back width thereof decreases as a distance from the neck 105 increases in the right-left direction with the portion having the maximum front-back width as a reference (see FIGS. 2, 3, and 5).

In addition, the left sound output device 1 and the right sound output device 1 are mounted on the holder 400 in a laterally symmetrical direction (see FIGS. 2 and 3). In the left sound output device 1, a portion having the maximum front-back width is present in a right half part, and a front-back width decreases toward the left side with the portion having the maximum front-back width as a reference. In the right sound output device 1, a portion having the maximum front-back width is present in a left half part, and a front-back width decreases toward the right side with the portion having the maximum front-back width as a reference.

The sound output device 1 is formed to have the above-described shape, the thickness direction thereof is an up-down direction, the width direction thereof is a front-back direction, the length direction thereof is a right-left direction, a size in the thickness direction is smaller than a size in the width direction, and a size in the width direction is smaller than a size in the length direction.

As described above, in the sound output device 1, the battery 30 is disposed in the disposition space 26, and the thickness direction of the battery 30 matches the thickness direction of the outer housing 2.

Thus, since the battery 30 is disposed in the disposition space 26 in a state where the thickness direction thereof matches the thickness direction of the outer housing 2, it is possible to achieve effective utilization of a disposition space of the disposition space 26, dispose the large-sized battery 30 in the disposition space 26, and achieve a reduction in the thickness of the sound output device 1 while securing sufficient capacity of the battery 30.

In addition, a plurality of circuit boards, that is, the circuit board 32 for a switch, the main circuit board 36, and the sub-circuit board 37 are disposed in the disposition space 26, and the thickness direction of at least one circuit board, for example, the circuit board 32 for a switch and the sub-circuit board 37 matches the thickness direction of the outer housing 2.

Thus, since at least one circuit board is disposed in the disposition space 26 in a state where the thickness direction thereof matches the thickness direction of the outer housing 2, the thickness directions of the at least one circuit board and the battery 30 match each other, and it is possible to achieve a further reduction in the thickness of the sound output device 1.

Further, the main circuit board 36 is disposed in a state of being inclined with respect to the thickness direction of the outer housing 2.

Thus, since the main circuit board 36 is disposed in the disposition space 26 in a state where the thickness direction thereof is different from the thickness direction of the outer housing 2, sizes in two directions, that is, the thickness direction of the outer housing 2 and a direction orthogonal to the thickness direction are not increased excessively, and thus it is possible to achieve a reduction in the size of the sound output device 1.

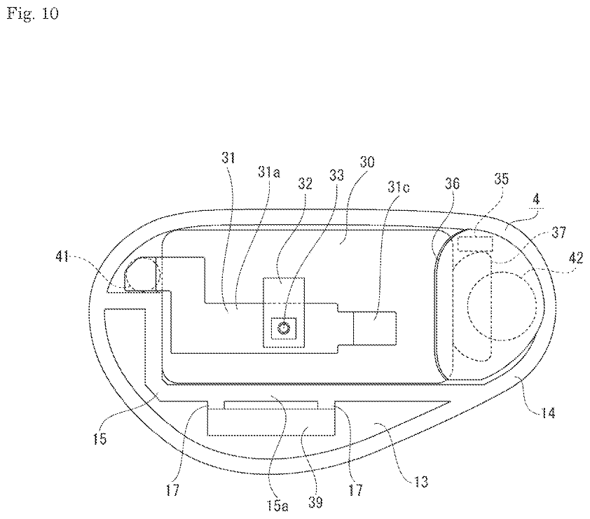

Further, at least one circuit board, for example, the main circuit board 36, the sub-circuit board 37, the battery 30, and the speaker 39 are disposed to be separated from each other in a direction orthogonal to the thickness direction of the outer housing 2 (see FIG. 10).

Thus, the main circuit board 36, the sub-circuit board 37, the battery 30, and the speaker 39 which are at least one circuit board are disposed in a state where they do not overlap each other in the thickness direction of the outer housing 2, and thus it is possible to achieve a further reduction in the thickness of the sound output device 1.

<Attachment or Detachment of Sound Output Device to or From Holder>

The sound output device 1 configured as described above is attachable or detachable to or from the holder 400 attached to the garment 200 (see FIGS. 2 and 3).

The mounting of the sound output device 1 on the holder 400 can be performed by inserting the sound output device 1 into an insertion space 401a of the disposition portion 401 from above (see FIGS. 3 and 4). In this case, in the sound output device 1, the magnetic metal plate 405 of the holder 400 is stuck onto the first magnet 41 and the second magnet 42.

By operating the operation button 34 in a state where the sound output device 1 is disposed in the disposition portion 401, a sound is output from the speaker 39, and a sound can be emitted to the outside through the sound emission holes 11, 11, . . . and the sound discharge holes 25, 25, . . . of the outer housing 2. The emitted sound goes to the ears 109 and 109, and a good sound field environment for the ears 109 and 109 is formed.

In addition, an example in which magnets (the first magnet 41 and the second magnet 42) are disposed in the sound output device 1, and the magnetic metal plate 405 is disposed in the holder 400 has been described above. In contrast, the magnetic metal plate may be disposed in the sound output device 1, and the magnets may be disposed in the holder 400.

In this manner, in the sound output device 1, the magnet is attached to any one of the outer housing 2 and the holder 400, the magnetic metal plate is attached to the other one, and the sound output device 1 is mounted on the holder 400 by sticking power of the magnet into the magnetic metal plate.

Thus, since the sound output device 1 is mounted on the holder 400 by the magnet and the magnetic metal plate approaching each other, and the sound output device 1 is removed from the holder 400 by the magnet and the magnetic metal plate being separated from each other, and thus it is possible to easily and reliably perform attachment or detachment of the sound output device 1 to or from the holder 400.

Further, in a case where the magnet is attached to the outer housing 2, the magnet is not present on the garment 200 side in a state where the sound output device 1 is not mounted on the holder 400, and thus it is possible to suppress the influence of the magnet on the human body 100. In particular, in a case where medical equipment or the like which is not desired to be affected by a magnetic force is worn on the body, a configuration in which a magnet is not present on the garment 200 side is more preferable.

Further, the outer housing 2 is formed in a shape having a longitudinal direction (right-left direction) and a transverse direction, and the first magnet 41 and the second magnet 42 which are a plurality of magnets are provided to be separated from each other in the longitudinal direction of the outer housing 2.

Thus, the sound output device 1 is mounted on the holder 400 by the magnetic metal plate 405 being stuck onto the first magnet 41 and the second magnet 42 which are disposed to be separated from each other in the longitudinal direction of the outer housing 2, and thus it is possible to secure a stable holding state of the sound output device 1 by the holder 400.

Further, an attaching/detaching direction of the sound output device 1 with respect to the holder 400 is the thickness direction of the sound output device 1, the sound output device 1 is configured such that two directions orthogonal to the thickness direction are a length direction and a width direction, and the size thereof in the thickness direction is smaller than the sizes thereof in the length direction and the width direction.

Thus, the size in the thickness direction matching the attaching/detaching direction is smaller than the sizes in the length direction and the width direction, and thus it is possible to achieve a reduction in the thickness of the sound output device 1.

In addition, since the sound output device 1 is formed to have an asymmetrical shape in the right-left direction, it is possible to recognize a direction in which the sound output device 1 is mounted on the holder 400 depending on the shape thereof and to prevent erroneous mounting of the sound output device 1 on the holder 400.

Further, the left sound output device 1 and the right sound output device 1 are respectively mounted on the holders 400 and 400 in a laterally symmetrical direction (see FIGS. 2 and 3).

Thus, it is possible to recognize on which holder 400 out of the holders on the right and left sides the sound output device 1 is mounted depending on the direction thereof, and it is possible to prevent erroneous mounting such as the left sound output device 1 being mounted on the holder 400 on the right side and the right sound output device 1 being mounted on the holder 400 on the left side.

In a state where the sound output device 1 is mounted on the holder 400 as described above, the sound output device 1 is disposed on the upper side of the shoulder 101.

Since the shoulder 101 is a portion that is not greatly displaced when the body is moved, and is a portion close to the ear 109, it is possible to make the sound output device 1 difficult to fall off from the holder 400 and it is possible to form a good sound field environment for the ear 109. In particular, it is possible to secure a stable use state of the sound output device 1 even in a large-motion exercise state such as a case of sports such as running.

Further, in a state where the sound output device 1 is disposed in the holder 400, the sound output device 1 is disposed in the shoulder upper portion 101a which is the rear side of the hollow 107 positioned behind the collarbone 106.

Thus, since the sound output device 1 is not disposed on the upper side of the hollow 107 positioned behind the collarbone 106, the orientation of the sound output device 1 hardly changes in a disposed state, and a direction in which a sound is emitted from the sound emission holes 11, 11, . . . hardly changes, thereby making possible to secure a stable sound emission state.

In a state where the sound output device 1 is disposed in the holder 400, a portion of the sound output device 1, for example, a lower half part is inserted into the insertion space 401b. Thus, the sound emission holes 11, 11, . . . formed in the cover body 3 and the sound discharge holes 25, 25, . . . formed in the protection rubber 5 are not blocked by the holder 400, and the emission ports 11a, 11a, . . . are positioned outside the disposition portion 401.

In a state where the sound output device 1 is inserted into the disposition portion 401 in this manner, the emission port 11a of the sound emission hole 11 is positioned outside the disposition portion 401.

Thus, since the emission port 11a of the sound emission hole 11 is not blocked by the holder 400 in a state where the sound output device 1 is inserted into the disposition portion 401, a sound output from the speaker 39 can be reliably emitted to the outside.

The sound output device 1 can be taken out of the holder 400 by gripping the sound output device 1 and extracting the sound output device 1 upward from the insertion space 401a of the disposition portion 401 with power larger than sticking power of the first magnet 41 and the second magnet 42 into the magnetic metal plate 405.

<Summary>

As described above, the sound output device 1 includes the outer housing 2 which includes the sound emission holes 11, 11, . . . and in which an internal space is formed as the disposition space 26, and the speaker 39 which is disposed in the disposition space 26 and outputs a sound outward through the sound emission holes 11, 11, . . . , and the sound output device 1 is configured to be attachable or detachable to or from the holder 400 attached to the garment 200.

Thus, it is possible to remove the sound output device 1 from the garment 200 in a case where the garment 200 is washed, and thus there is no concern that the sound output device 1 may be broken or damaged due to an impact or the like during washing. In addition, also in a case where maintenance is performed on the sound output device 1, it is possible to remove the sound output device 1 from the garment 200 and to achieve an improvement in workability in maintenance work.

In this manner, the sound output device 1 is attachable or detachable to or from the holder 400 attached to the garment 200 as necessary, the sound output device 1 can be removed from the holder 400 in an unused state or during maintenance, a failure or damage hardly occurs, an improvement in workability in maintenance work is also achieved, and an improvement in usability can be achieved.

In addition, the sound output device 1 is attachable or detachable to or from the holder 400 in the up-down direction, and thus it is possible to attach or detach the sound output device 1 for the holder 400 to or from the shoulder 101 by moving a hand vertically and to easily perform attachment or detachment of the sound output device 1 in a visually recognizable range. In addition, the sound output device 1 is not limited to the shoulder 101, and may be positioned, for example, at a position corresponding to the arm 102, the neck 105, or the trunk 103 in a state where the sound output device 1 is disposed in the holder.

Further, the disposition portion 401 is formed in the holder 400, and the sound output device 1 is disposed in a state where a portion thereof is inserted into the disposition portion 401.

Thus, since the sound output device 1 is mounted on the holder 400 in a state where a portion thereof is inserted into the disposition portion 401, it is possible to mount the sound output device 1 on the holder 400 with high positional accuracy and it is possible to make the sound output device 1 difficult to fall off from the holder 400.

Further, the sound emission holes 11, 11, . . . are inclined with respect to both the thickness direction of the outer housing 2 and a direction orthogonal to the thickness direction.

Thus, the emission ports 11a, 11a, . . . in the sound emission holes 11, 11, . . . can be positioned at any location of the outer housing 2, and it is possible to achieve an improvement in the degree of freedom of design of the sound output device 1 and set a sound emission direction to be a desired direction.

<Others>

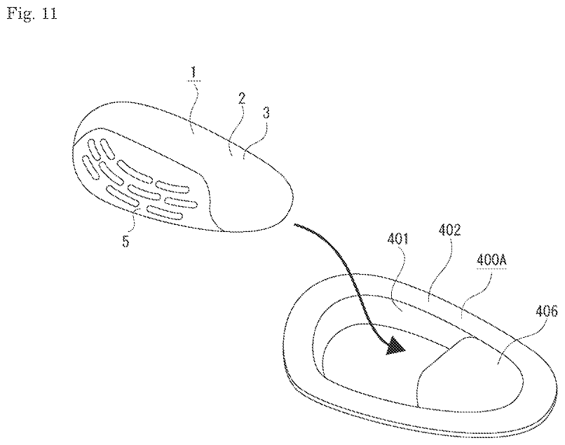

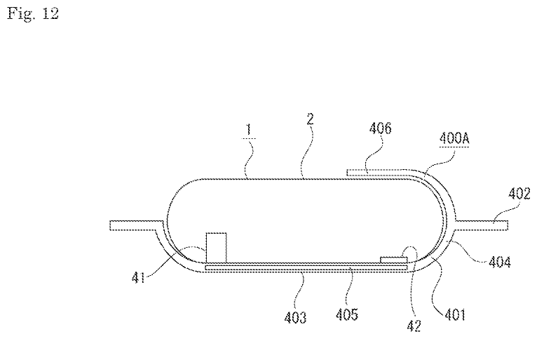

Although the holder 400 including the disposition portion 401 formed to have a concave shape and the flange-shaped junction portion 402 extending outward from the opening 401a of the disposition portion 401 has been described above as an example, for example, a holder 400A may be used instead of the holder 400 (see FIGS. 11 and 12).

The holder 400A is provided with a pressing portion 406 continuous with the junction portion 402, in addition to the disposition portion 401 and the junction portion 402. The pressing portion 406 is formed to have a curved surface shape in which the lower end portion thereof is continuous with a portion of the junction portion 402 and which covers a portion of the disposition portion 401 from above.

The mounting of the sound output device 1 on the holder 400A can be performed by sliding the sound output device 1 along the sheet 300 in a substantially right-left direction and inserting the sound output device 1 into the insertion space 401a of the disposition portion 401. In this case, in the sound output device 1, the magnetic metal plate 405 of the holder 400 is stuck onto the first magnet 41 and the second magnet 42, and a portion of the outer housing 2 is pressed by the pressing portion 406 from above.

The sound output device 1 can be taken out of the holder 400A by gripping the sound output device 1, sliding the sound output device 1 sideward with power larger than sticking power of the first magnet 41 and the second magnet 42 into the magnetic metal plate 405, and extracting the sound output device 1 sideward from the insertion space 401a of the disposition portion 401.

In this manner, the holder 400A is provided with the pressing portion 406 that presses the outer housing 2 from a direction opposite to the opening direction of the disposition portion 401.

Thus, since the sound output device 1 is inserted into the disposition portion 401 and is mounted on the holder 400A in a state where the outer housing 2 is pressed by the pressing portion 406 from a direction opposite to the opening direction of the disposition portion 401, it is possible to secure a stable mounting state of the sound output device 1 with respect to the holder 400A.

<Present Technology>

The present technology can be configured as follows.

(1)

A sound output device including:

an outer housing which includes a sound emission hole and in which an internal space is formed as a disposition space; and

a speaker which is disposed in the disposition space and outputs a sound outward through the sound emission hole, wherein the sound output device is attachable or detachable to or from a holder attached to a garment.

(2)

The sound output device according to (1), wherein the sound output device is disposed on an upper side of a shoulder in a state of being mounted on the holder.

(3)

The sound output device according to (2), wherein the sound output device is disposed on a rear side of a hollow positioned behind a collarbone.

(4)

The sound output device according to (2) or (3), wherein the sound output device is attachable or detachable to or from the holder in an up-down direction.

(5)

The sound output device according to any one of (1) to (4), wherein

a concave-shaped disposition portion is formed in the holder, and

the sound output device is disposed in a state where a portion thereof is inserted into the disposition portion.

(6)

The sound output device according to (5), wherein an emission port of the sound emission hole is positioned outside the disposition portion in a state where the sound output device is inserted into the disposition portion.

(7)

The sound output device according to (5) or (6), wherein the holder is provided with a pressing portion that presses the outer housing from a direction opposite to an opening direction of the disposition portion.

(8)

The sound output device according to any one of (1) to (7), wherein the sound output device is formed to have an asymmetrical shape in a right-left direction.

(9)

The sound output device according to (8), wherein

a pair of right and left sound output devices are provided, and

the right and left sound output devices are mounted on the holder in a laterally symmetrical direction.

(10)

The sound output device according to any one of (1) to (9), wherein an outer surface portion of the outer housing includes a flat surface portion and a curved surface portion which is continuous with an outer periphery of the flat surface portion.

(11)

The sound output device according to any one of (1) to (10), wherein

a magnet is attached to one of the outer housing and the holder, and a magnetic metal plate is attached to the other one, and

the sound output device is mounted on the holder in a state where the magnetic metal plate is stuck onto the magnet.

(12)

The sound output device according to (11), wherein

the magnet is attached to the outer housing, and

the magnetic metal plate is attached to the holder.

(13)

The sound output device according to (12), wherein

the outer housing is formed in a shape having a longitudinal direction and a transverse direction, and

a plurality of the magnets are provided to be separated from each other in the longitudinal direction of the outer housing.

(14)

The sound output device according to any one of (1) to (13), wherein

an attaching/detaching direction with respect to the holder is a thickness direction, two directions orthogonal to the thickness direction are a length direction and a width direction, and

a size in the thickness direction is smaller than sizes in the length direction and the width direction.

(15)

The sound output device according to any one of (1) to (14), wherein

a battery is disposed in the disposition space, and

a thickness direction of the battery matches the thickness direction of the outer housing.

(16)

The sound output device according to (15), wherein

a plurality of circuit boards are disposed in the disposition space, and

a thickness direction of at least one of the circuit boards matches the thickness direction of the outer housing.

(17)

The sound output device according to (16), wherein one of the circuit boards is disposed in a state of being inclined with respect to the thickness direction of the outer housing.

(18)

The sound output device according to (16) or (17), wherein at least one of the circuit boards, the battery, and the speaker are disposed to be separated from each other in a direction orthogonal to the thickness direction of the outer housing.

(19)

The sound output device according to any one of (1) to (18), wherein the sound emission hole is inclined with respect to both the thickness direction of the outer housing and a direction orthogonal to the thickness direction.

(2)

The sound output device according to any one of (1) to (19), wherein

a button disposition hole is formed in the outer housing,

an operation portion is disposed in the button disposition hole,

a protection cover formed of a cloth material is adhered to at least a portion of a surface in the outer housing, and

the operation portion is covered with the protection cover.

### REFERENCE SIGNS LIST

101 Shoulder
106 Collarbone
107 Hollow
200 Garment
400 Holder
401 Disposition portion
405 Magnetic metal plate
1 Sound output device
2 Outer housing
6 Flat surface portion
7 Curved surface portion
11 Sound emission hole
11a Emission port
22 Flat surface portion
23 First curved surface portion
24 Second curved surface portion
26 Disposition space
29 Protection cover
30 Battery
32 Sub-circuit board for switch
34 Operation button
36 Main sub-circuit board
37 Sub-circuit board
39 Speaker
41 First magnet
42 Second magnet
400A Holder
406 Pressing portion

What is claimed is:

1. A sound output device, comprising:
an outer housing which includes a sound emission hole and in which an internal space is formed as a disposition space; and
a speaker which is disposed in the disposition space and outputs a sound outward through the sound emission hole, wherein the sound output device is attachable or detachable to or from a holder attached to a garment.

2. The sound output device according to claim 1, wherein the sound output device is disposed on an upper side of a shoulder in a state of being mounted on the holder.

3. The sound output device according to claim 2, wherein the sound output device is disposed on a rear side of a hollow positioned behind a collarbone.

4. The sound output device according to claim 2, wherein the sound output device is attachable or detachable to or from the holder in an up-down direction.

5. The sound output device according to claim 1, wherein
a concave-shaped disposition portion is formed in the holder, and the sound output device is disposed in a state where a portion thereof is inserted into the disposition portion.

6. The sound output device according to claim 5, wherein an emission port of the sound emission hole is positioned outside the disposition portion in a state where the sound output device is inserted into the disposition portion.

7. The sound output device according to claim 5, wherein the holder is provided with a pressing portion that presses the outer housing from a direction opposite to an opening direction of the disposition portion.

8. The sound output device according to claim 1, wherein the sound output device is formed to have an asymmetrical shape in a right-left direction.

9. The sound output device according to claim 8, wherein
a pair of right and left sound output devices are provided, and
the right and left sound output devices are mounted on the holder in a laterally symmetrical direction.

10. The sound output device according to claim 1, wherein an outer surface portion of the outer housing includes a flat surface portion and a curved surface portion which is continuous with an outer periphery of the flat surface portion.

11. The sound output device according to claim 1, wherein
a magnet is attached to one of the outer housing and the holder, and a magnetic metal plate is attached to the other one, and
the sound output device is mounted on the holder in a state where the magnetic metal plate is stuck onto the magnet.

12. The sound output device according to claim 11, wherein
the magnet is attached to the outer housing, and
the magnetic metal plate is attached to the holder.

13. The sound output device according to claim 12, wherein
the outer housing is formed in a shape having a longitudinal direction and a transverse direction, and
a plurality of the magnets are provided to be separated from each other in the longitudinal direction of the outer housing.

14. The sound output device according to claim 1, wherein
an attaching/detaching direction with respect to the holder is a thickness direction,
two directions orthogonal to the thickness direction are a length direction and a width direction, and
a size in the thickness direction is smaller than sizes in the length direction and the width direction.

15. The sound output device according to claim 1, wherein
a battery is disposed in the disposition space, and
a thickness direction of the battery matches the thickness direction of the outer housing.

16. The sound output device according to claim 15, wherein
a plurality of circuit boards are disposed in the disposition space, and
a thickness direction of at least one of the circuit boards matches the thickness direction of the outer housing.

17. The sound output device according to claim 16, wherein one of the circuit boards is disposed in a state of being inclined with respect to the thickness direction of the outer housing.

18. The sound output device according to claim 16, wherein at least one of the circuit boards, the battery, and the speaker are disposed to be separated from each other in a direction orthogonal to the thickness direction of the outer housing.

19. The sound output device according to claim 1, wherein the sound emission hole is inclined with respect to both the thickness direction of the outer housing and a direction orthogonal to the thickness direction.

20. The sound output device according to claim 1, wherein
a button disposition hole is formed in the outer housing,
an operation portion is disposed in the button disposition hole,
a protection cover formed of a cloth material is adhered to at least a portion of a surface in the outer housing, and
the operation portion is covered with the protection cover.
